(19) United States
(12) Patent Application Publication
(10) Pub. No.: US 2010/0313182 A1
(43) Pub. Date: Dec. 9, 2010

(54) EXTENSIBLE USER INTERFACE GENERATION

(75) Inventors: John Z. Chen, Woodinville, WA (US); Antoine Cote, Shanghai (CN); Shichao Hu, Shanghai (CN); Tao Sheng Hu, Shanghai (CN); Yang Cao, Shanghai (CN); Yaohai Zheng, Shanghai (CN)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/478,781

(22) Filed: Jun. 5, 2009

(51) Int. Cl. G06F 9/44; G06F 3/048

(52) U.S. Cl. 717/109

(57) ABSTRACT

A data source extensibility model establishes extensibility points to allow a data source window or integrated development environment to work with new data source providers and/or new designer technologies and/or new UI controls. Various object/entity management techniques are provided to orchestrate which component is present in given conditions.

### BACKGROUND

Rapid application development (RAD) is a term originally coined in 1991 to describe a software development process introduced by James Martin. Martin's approach involved iterative development and the construction of prototypes. The term has come to be used in a broader, more generic sense. As the term is used now, it encompasses various techniques for speeding up application development, including techniques for development of data applications and forms that access and display data.

One aspect of RAD involves providing easier ways to create forms. Developers typically want to be able to easily create controls based on a schema, to have a precise layout for each control, to map data types to specific controls, to be able to vary the default control for a particular column or property, to add custom controls to the list of available controls, to create a label for a control, to establish data binding for a control, to be able to assign meaningful names to a control and so on.

### SUMMARY

A data source extensibility model based on data sources establishes extensibility points to allow a data source window or integrated development environment to work with new data source providers and/or new designer technologies and/or new UI (user interface) controls. Various object/entity management techniques are provided to orchestrate which component is present in given conditions. A generalized data model is generated from a new type of data source received by the extensible data application. A data sources display displays any data source in the generalized data model format. User input associating a data binding control with an element of the new type of data source is received. The extensible data application development module automatically generates user interface code, controls, objects and data application code based on combinations of one or more of: the data source, designer, and data binding control based on received user input and software-detected elements.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings:

FIG. 1a is a block diagram of an example of an extensible system for development of data applications in accordance with aspects of the subject matter disclosed herein;

FIG. 1b is a block diagram of an example of a data flow within an extensible system for development of data applications in accordance with aspects of the subject matter disclosed herein;

FIG. 1c is a block diagram of an example of groups of components in an extensible system for development of data applications in accordance with aspects of the subject matter disclosed herein;

FIG. 1d is a block diagram illustrating an example of a hierarchical organization of components of an extensible system for development of data applications in accordance with aspects of the subject matter disclosed herein;

FIG. 2 is a flow diagram of an example of an extensible method for development of data applications in accordance with aspects of the subject matter disclosed herein;

FIG. 3 is a block diagram illustrating an example of a computing environment in which aspects of the subject matter disclosed herein may be implemented; and

FIG. 4 is a block diagram of an example of an integrated development environment in accordance with aspects of the subject matter disclosed herein.

### DETAILED DESCRIPTION

### Overview

Microsoft's Visual Studio 2005 introduced a simple, powerful model for development of forms. The Visual Studio Data Sources Window is a tool window that displays objects within a project that can be used to create data bound forms. The Data Sources Window as it is known today can display several different types of data sources including typed user defined objects (such as but not limited to business objects), Web services and DataSets. A DataSet type is a type definition of a dataset. A dataset is a copy of data in memory and can comprise a number of data tables, each of which typically corresponds to a database table or view.

A developer can also work from the Toolbox. In addition to the Drag and Drop Data Binding feature accessible from the Data Sources Window, the Data Sources Window also has a feature called “Connect the Dots”. To “connect the dots” a developer can lay out a form using controls, etc. from the ToolBox and then drag elements from the Data Sources Window onto existing controls. Instead of creating a new control, the Data Sources Window establishes the data binding to the default binding property of the existing control using additional data binding attributes. Labels are not created and the name of the control is not changed.

The Data Sources Window as known today supports a closed set of different types of data sources, each of which are handled slightly differently. The BindingSource is a WinForms control that provides the ability to bind to types, in addition to binding to instances of component objects. Typed DataSets defined in a particular project with an .xsd file extension are automatically displayed in the Data Sources Window. A user-defined class that inherits from the DataSet class will not be added to the Data Sources Window automatically, but it can be added manually. Each DataTable of the DataSet is listed with its corresponding list of columns. Any Web service references that have been added are also automatically displayed in the Data Sources Window. Each Web method is evaluated and the public properties of the object returned by that method are displayed within the Data Sources Window. The definition of the implementation of a user defined object (done by creating public properties) is left up the developer. Interfaces and provision of a default constructor are handled by Visual Studio. New data sources can be added to the Data Sources Window by adding an object to the Data Sources Window using the Add New Data Source command.

### Extensible Data Application Development

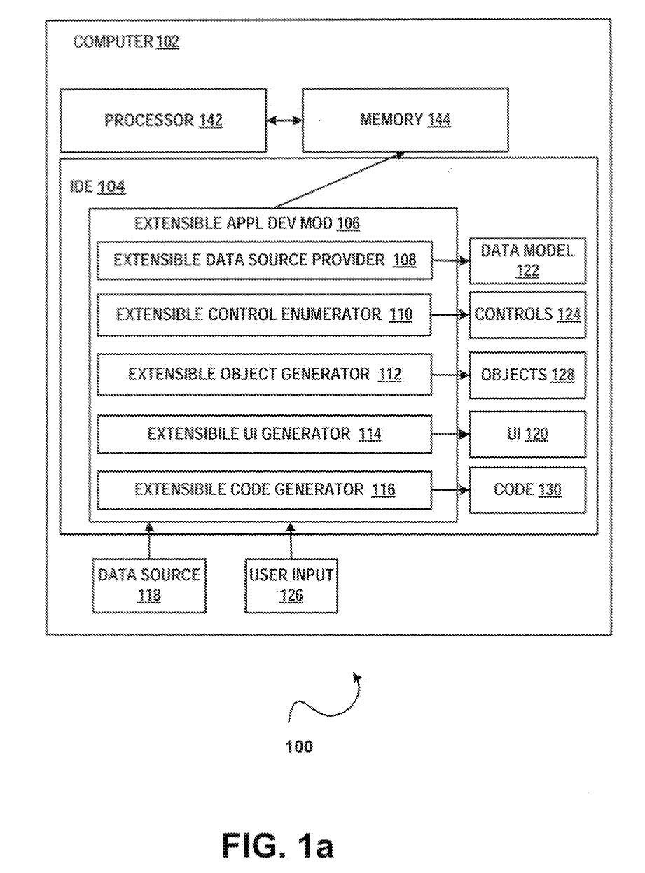

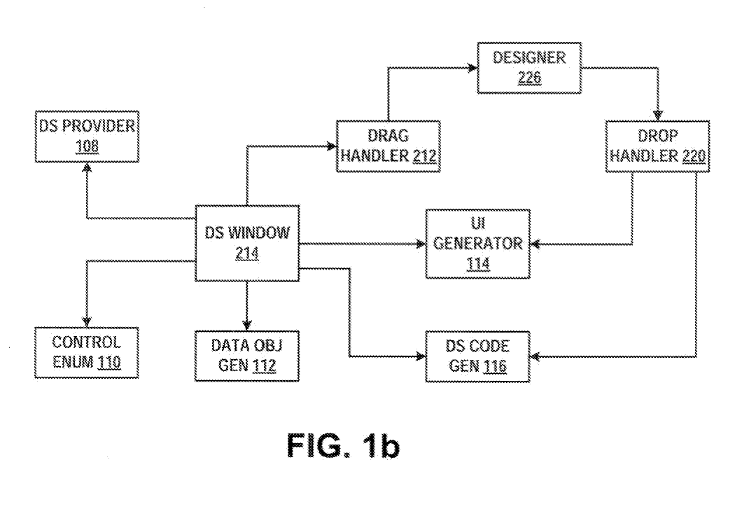

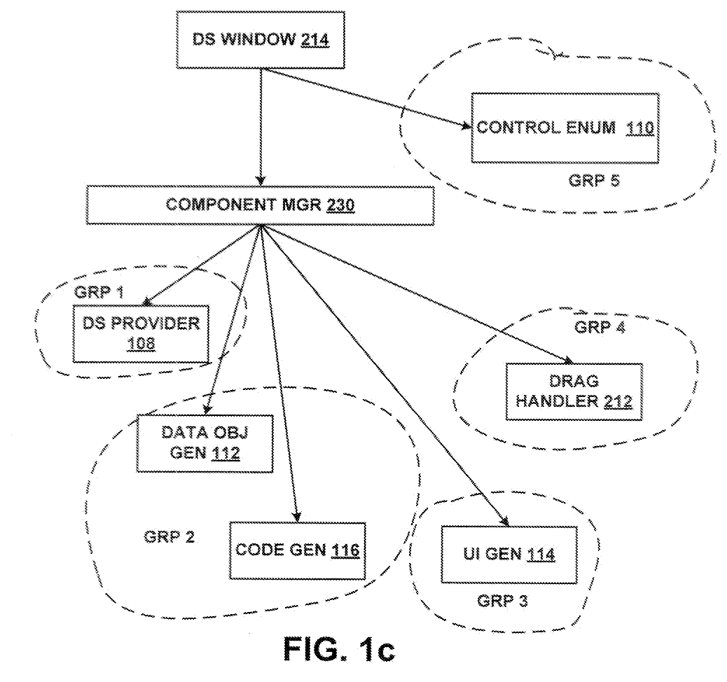

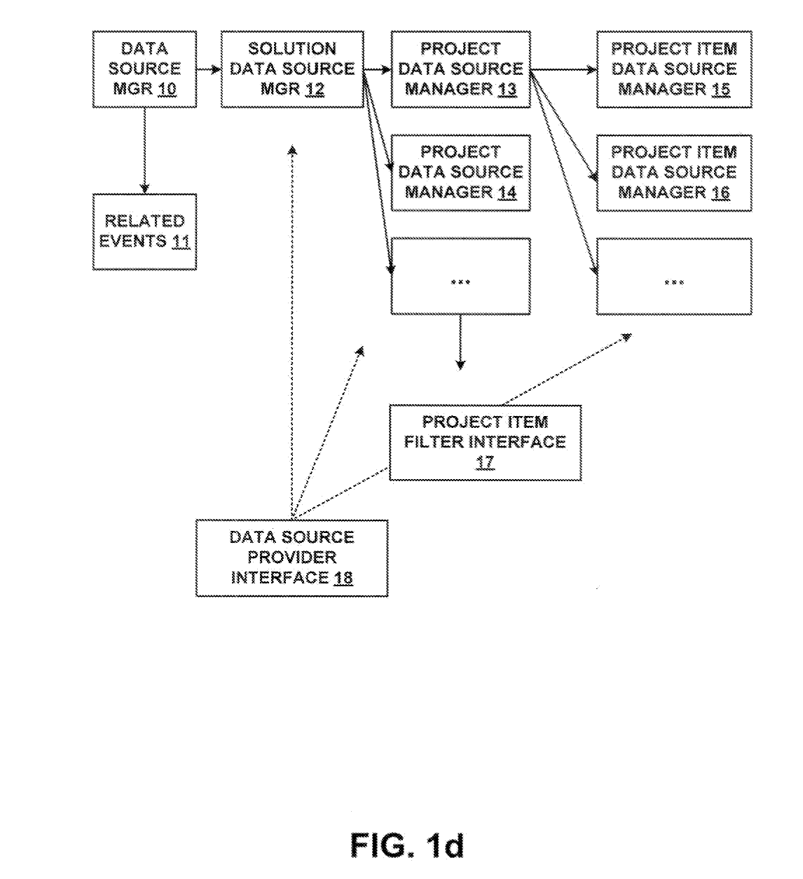

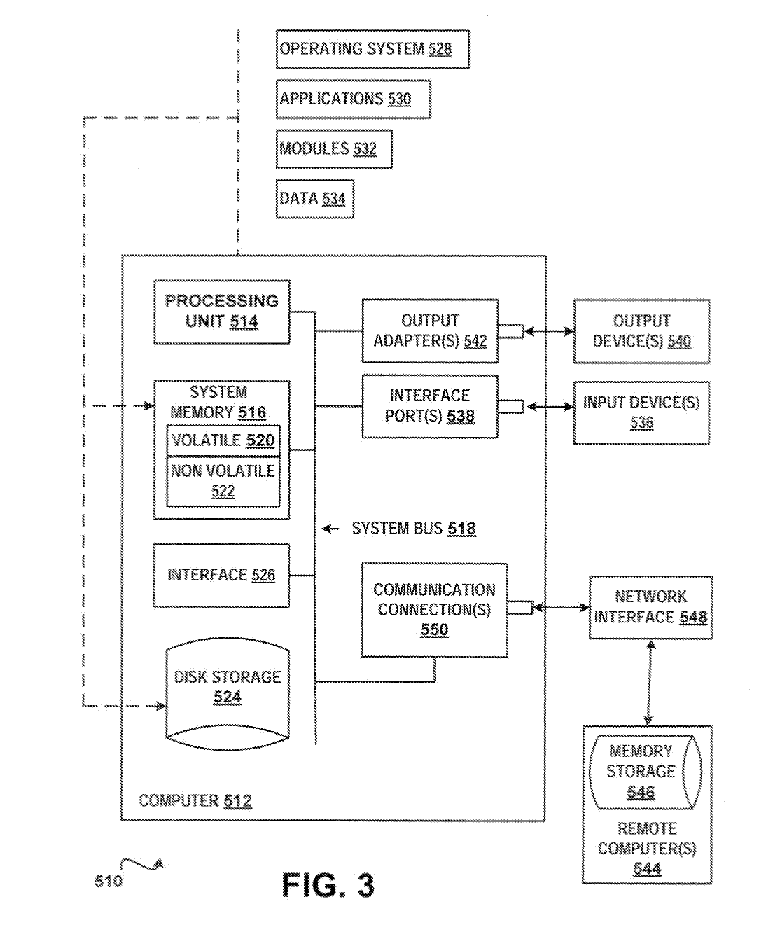

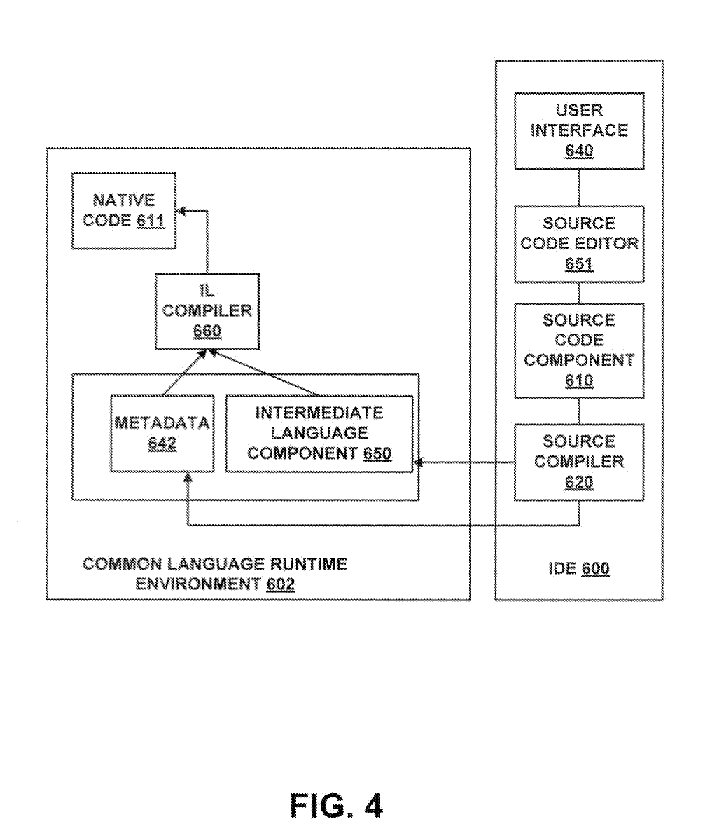

An extensible system for data application development and user interface generation is described below. The system automatically adds new data models generated from new types of data sources to those displayed in the Data Sources Window and automatically generates user interfaces and code for the new data source. It receives user input to associate data binding controls with elements of the new data source, and generates new data objects, user interfaces and new data application code. FIG. 1a illustrates an example of an extensible system 100 for data application development in accordance with aspects of the subject matter disclosed herein. All or portions of system 100 may reside on one or more computers such as the computers described below with respect to FIG. 3. All or portions of system 100 may reside on one or more software development computers (e.g., computer 102) such as the computers described below with respect to FIG. 4. The system 100 or portions thereof may comprise a portion of an integrated development environment (e.g., IDE 104) such as the ones described and illustrated below with respect to FIG. 4. Alternatively, system 100 or portions thereof may be provided as a stand-alone system or as a plug-in or add-in.

System 100 may include one or more of: a processor (such as processor 142), a memory 144, and an extensible data application development module 106. Other components well known in the arts may also be included but are not here shown. It will be appreciated that extensible data application development module 106 can be loaded into memory 144 to cause one or more processors such as processor 142 to perform the actions attributed to the extensible data application development module 106. Extensible data application development module 106, in accordance with aspects of the subject matter disclosed herein, may receive user input 126 and a data source 118 and generate one or more of: a new data model 122, a new control 124, a new object 128, a new UI 120 or new data application code 130 based on the user input 126 and one or more new data sources 118 or new control(s) provided. Extensible data application development module 106 according to some aspects of the subject matter disclosed herein can support MEF (Managed Extensibility Framework) implementations. MEF enables extensibility by permitting applications to be dynamically composed rather than being statically compiled.

Extensible data application development module 106 can include one or more of the following: an extensible data source provider represented in FIG. 1a by extensible data source provider 108, an extensible control enumerator represented in FIG. 1a by extensible control enumerator 110, an extensible data object generator and drag handler represented in FIG. 1a by extensible data object generator/drag handler 112, an extensible UI generator represented in FIG. 1a by extensible UI generator 114 and an extensible application code generator 116. Extensible data source provider 108 is extensible because any data model can plug into a data source window displaying data sources as a new data source provider. A new data source can be added through a data source wizard. An existing data source wizard can be extended for a new data model or a new type of data source. For example, a data source wizard could be extended for an Entity Data Model to enable a user to add an EDM data source with the extended data source wizard. An extensible data source provider 108 can plug into a data source window to display all instances of the EDM data model.

Extensible control enumerator 110 provides for extensible mapping between controls and a combination of designer technology and data type. Extensibility is provided in the extensible object generator/drag handler 112 by having a different object generator for each data source provider/designer combination. Contemplated designers include but are not limited to WinForm, WPF and Silverlight designers. Extensibility in the extensible UI generator 114 is provided by having a different UI generator for each designer/binding control combination. Extensibility in the extensible application code generator 116 is provided by having a different code generator for each designer/data source combination.

It will be understood although the following is described within the context of Visual Studio, the subject matter described herein can be applied to any data application development software. Data sources can be persisted as project items. The file extension can indicate the type of data source it is. For example, a file extension of .edmx can indicate an EDM data source while a DataSet data source can be indicated by a file extension of .xsd. Each Visual Studio solution can include one or more projects and each project can include one or more project items related to particular data sources. Data sources share events such as add, remove and update. Projects share add, remove, and solution open and solution close events. Components that handle these types of events can be shared.

Points of extensibility are related to characteristics that are not shared by different data sources. Each different data source has its own implementation for unshared characteristics. For example, in accordance with aspects of the subject matter disclosed herein, the type of the project items is not a shared characteristic for project items. That is, the file format, and file extension indicator differs for different types of project items. Hence, an EDM data source may end with the file extension .edmx while a DataSet may end with a .xsd file extension. Each different data source provider can be associated with a particular project item filter interface to filter out unrelated project items so that the data source manager described below can narrow its scope to manage only those project items that are related to a particular data source provider. The content loading logic for different data sources can be different. Each different data source can have its own project item data source manager interface to read the data source project items and to parse the content of a data source project item. A general interface format can be constructed from the contents of the data source so that many components can be shared.

FIG. 1b is a diagram depicting components of the extensible data application development module (and other components) in operation. Referring concurrently now, to FIGS. 1a and 1b, data source window 214 can display recognized data sources within the project. An extensible data source provider 108 can discover recognizable data sources within a project and can construct them in a generalized format so that the data sources can be displayed by data source window 214. Different data source providers (of which extensible data source provider 108 is one example and which may also include data source providers that are not extensible (not shown)) can be called to construct a data model such as data model 122 from a data source such as data source 118, where the constructed data model 122 is compatible with a generic data source interface.

Extensible data source provider 108 can also listen for data source events including update, add and remove events and can update data model 122 accordingly. When processing of updates is complete, a data source changed event can be fired to notify others of the change.

FIG. 1d illustrates the hierarchical nature of the extensible data application development module. A generic data source provider interface 18 can retrieve data sources in the solution or in any project including those in different solutions. A single instance of a data source manager 10 of extensible data source provider 108 can manage data sources within an instance of the IDE. A project item filter accessed via a project item filter interface 17 can be used to filter out project items that are unrelated to a particular data source provider. The data source manager 10 can listen for appropriate events 11 and in response to detecting such an event, take appropriate actions to ensure that appropriate data sources are updated. The data source manager 10 can use a single instance of a solution data source object (e.g. a solution data source manager 12) to manage data sources in a solution.

The solution data source object can manage data sources in a solution. The solution data source object can use a project item filter accessed with a project item filter interface to filter out project items that are unrelated to the data source provider. The solution data source object can be associated with APIs (application programming interfaces) such as but not limited to Add Project, Contains Project, and Remove Project to manage project events. The solution data source object can also be associated with APIs that reload data sources, notify others that a data source has changed and that get or load data sources. The solution data source object can call a project data source object to manage data sources in a project (e.g., project data source manager 13, 14, etc.).

The project data source object in accordance with some aspects of the subject matter disclosed herein is responsible for managing the data sources in a project. The project data source object can call the project item filter interface 17 to filter out project items unrelated to a data source provider. The project data source object can be associated with APIs that add a project item, list project items contained by a project or remove a project item. The project data source object can also be associated with APIs that reload data sources, notify others that a data source has changed and that get or load data sources in the project. The project data source object can call a project item data source object interface 15, 16, etc. to manage data sources in a project.

The project item data source interface in accordance with some aspects of the subject matter disclosed herein is responsible for managing data sources in a project item. For example, an entity data model (EDM) project item data source may be responsible for loading all EDM data sources in a project item having a file extension of .edmx. The project item data source interface can be associated with APIs that get all data sources in the project item, check to see if the data source in the project item has changed and to reload all data sources in the project item.

The project item filter interface in accordance with some aspects of the subject matter disclosed herein is responsible to filter out all project items that are not related to an associated data source provider. For example, an EDM provider can be related to project items having a file extension of .edmx so that a method called on a project item may return true for a valid .edmx project item and return false for those that do not have a file extension of .edmx.

The Entity Framework for EDM is a set of technologies in ADO.NET that supports development of data-oriented software applications. The Entity Framework enables a developer to work with data in the form of domain-specific objects and properties, such as customers and customer addresses, without having to deal with the underlying data tables and columns where the data is stored. The ADO.NET Entity Framework elevates the level of abstraction at which a developer can work when he or she deals with data and decreases the amount of code needed to create and maintain data-oriented applications.

ADO.NET also has a set of metadata defined to provide both the infrastructure and type hierarchy to describe the Entity Data Model in the Entity Framework. The ADO.NET MetadataWorkspace class is the central runtime API that enables a developer to access EDM metadata in the context of an application. The EDM model includes four model definitions: The Object Model (CLR) contains the definition in the CLR type layer. The Conceptual Model (CSDL) contains the definition of a design template for the object model. The Storage Model (SSDL) contains the definition of a formal description of the data source that persists data. The mapping between types declared in CSDL and SSDL is defined in Mapping Model (MSL). The mapping between CLR and CSDL is defined by class and property attributes in CLR layer.

Valid EDM data sources (i.e., those data sources in the format of .edmx) are discovered in the project. Hierarchy and type information of entity data sources are extracted from metadata of an assembly (e.g., a CLR assembly). The extracted hierarchy and type information can be used to construct the data source in the format of schema types/properties which can be used by the Data Source Window to display data and to perform data binding, etc.

In accordance with aspects of the subject matter disclosed herein, data source management for an EDM provider is performed by implementing the project item filter interface and the project item data source interface. The EDM project item filter can be used to filter out the project items that are not related to EDM data sources. When initializing a data source manager object, an EDM project item filter can be passed to the data source manager object, so that project items lacking the .edmx file extension are ignored. The EDM project item filter can create the EDM project item data source to manage data sources in the EDM project item. The EDM project item data source can include APIs to reload, determine if the data source has changed and get the data source, as described above.

Referring again to FIG. 1b, data source window 214 can get binding controls from an extensible control enumerator 110. Known control enumeration services hardcode associations between a closed set of types and controls. In accordance with aspects of the subject matter disclosed herein, the bindable control set is extensible. That is, a particular set of controls can be associated with a particular type of designer and a particular data type. That is, for a given data source type and a given designer technology, an appropriate set of controls will be displayed in the data source window 214. That is, for a given designer, (e.g., designer 226) the binding controls appearing in the dropdown list will be binding controls for that designer. For example, for a WPF designer, WPF binding controls will be listed in the dropdown list.

For a WinForm designer, WinForm binding controls will be listed in the dropdown list. Moreover, the customization dialog associated with the control can be a dialog that is customized for that designer. For example, the dialog that appears for a WinForm designer binding control can be a dialog customized for the WinForm designer binding control and the dialog that appears for a WPF designer binding control can be a dialog customized for the WPF designer binding control.

Finally, the control enumerator can accept a user selection to bind a customer control to a specific data type. In accordance with some aspects of the subject matter disclosed herein, the extensible control enumerator 110 can be implemented by calling a unified interface to detect current designer 226, providing the current designer to the extensible control enumerator 110, requesting the appropriate binding control list from the extensible control enumerator 110 and retrieving the bindable controls from a collection of bindable controls in a toolbox. In response to user input registering the customer control in toolbox, the new customer control is selectable in the type-control binding dialog.

Extensible data object generator/drag handler 112 provides another extensibility point. When an element from the data source window 214 is dragged from the data source window by a drag handler 212 and dropped onto a form, a data object is generated by an extensible data object generator/drag handler 112. The data object is generated in a format that can be understood and handled by the designers. That is, when any node from the data source window 214 is dragged or copied, a proper object can be generated therefrom. In accordance with some aspects of the subject matter disclosed herein, the generated data object implement an interface wherein any object that can receive data calls the methods in the implemented interface. When the data transfer method in the implemented interface is called, a format, a medium, and optionally, a target device for which the data should be rendered are specified. Objects, such as containers, that are to be notified through their advise sinks when the data in the data object changes call advisory methods of the implemented interface to set up an advisory connection through which notifications can be sent.

The generated drag object can include the information needed during the drop operation for UI and code generation. The information that is needed varies from one data source to another. For example, to drag and drop a dataset data source a table adapter is needed, hence the need for a data object generator. In accordance with some aspects of the subject matter disclosed herein, extensibility of the extensible data object generator/drag handler 112 can be achieved by having a different data object generator for data source for each provider/designer pair, picking up the appropriate data object generator and calling the unified interface to create the new data object in the correct format. In accordance with some aspects of the subject matter disclosed herein, MEF manages the data object generators.

When an element is dragged from the data source window by a drag handler 212 and dropped onto a designer by a drop handler 220, the UI generation and code generation is extensible, in accordance with aspects of the subject matter disclosed herein so that an appropriate UI and appropriate data binding and loading code is generated. This can be achieved by having a different extensible UI generator 114 for each designer/binding control pair, having a different extensible application code generator 116 for each designer/data source provider pair, selecting the appropriate extensible UI generator 114 and data source code generator 218 for the designer/data source provider combination and calling the unified interface to execute the UI and code generation process. In accordance with some aspects of the subject matter disclosed herein, MEF manages the UI/Code generators.

FIG. 1c illustrates an example of componentization of an extensible data application development module in accordance with aspects of the subject matter disclosed herein. In FIG. 1c, the data source window 214 may call the component manager such as an MEF component manager 230 to load components. Extensible data source providers 108 are independent of controls and designers: that is extensible data source providers (group 1) are not related to any designer or to any particular set of controls. Extensible data object generator/drag handler 112 and extensible application code generator 116 comprise a second group. Members of the second group are related to both a designer and to an extensible data source provider. For example, a first extensible data object generator/drag handler 112 and a first code generator may be associated with an EDM data source and a WPF designer while a second extensible data object generator (not shown) and a second code generator (not shown) may be associated with an EDM data source and a WinForm designer.

A third group of components can comprise extensible UI generators (e.g., UI generator 114). This group is related to a combination of designer and control. For example, a first UI generator may correspond to a WPF designer and a data grid control while a second UI generator may correspond to a WPF designer and a text box control. A fourth group can comprise drag handlers 212 managed by the component manager 230. Drag handlers in accordance with aspects of the subject matter disclosed herein can be designer sensitive, so that for example, a first drag handler may work with WinForm designer and a second drag handler may work with WPF designer. Finally, the fifth group comprises a control enumerator group, (e.g., control enumerator 110), that is designer sensitive and is not controlled by the component manager 230.

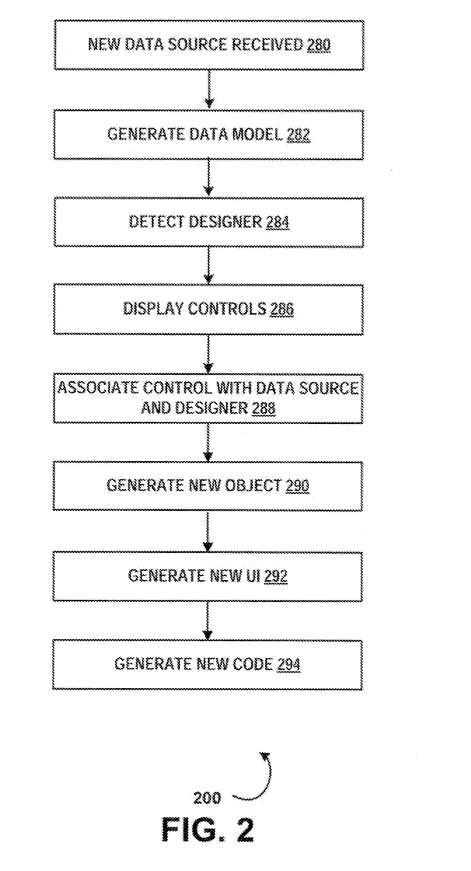

FIG. 2 illustrates an example of a method 200 for extending a data application in accordance with aspects of the subject matter disclosed herein. At 280 a new data source can be added to the project in a solution. At 282 a generalized data model can be generated from the new data source. An extensible data source provider can discover a recognizable data source within a project and can construct from it a data model in a generalized format so that the data sources can be displayed by a data source window, as described more fully above. The constructed data model can be constructed in such a way that it is compatible with a generic data source interface. At 284 the current designer can be detected. In accordance with some aspects of the subject matter disclosed herein, a unified interface can be called to detect current designer and the detected current designer can be provided to the extensible control enumerator.

At 286 an appropriate set of controls for the generalized data model can be displayed. An appropriate binding control list can be requested from the extensible control enumerator, as described above. The control enumerator can retrieve the bindable controls from a collection of bindable controls in a toolbox. In response to user input registering a customer control in toolbox, the new customer control can be selectable in the type-control binding dialog. At 288 in response to user input, a selected control can be associated with a data source type and the detected designer. A generated drag object can include the information needed during a drop operation for UI and code generation. The information that is needed may vary from one data source to another.

At 290 a new data object can be generated. A different object can be generated for the data source for each data provider/designer pair by retrieving the appropriate data object generator and calling the unified interface to create the new data object in the correct format. In accordance with some aspects of the subject matter disclosed herein, MEF manages the data object generators. At 292 a new UI can be generated. A different UI generator can be created for each designer/binding control pair or combination and calling the unified interface. At 294 new code can be generated. A different code generator can be created for each designer/extensible data source provider pair, selecting the appropriate data source code generator for the designer/extensible data source provider combination and calling the unified interface to execute the code generation process.

### Example of a Suitable Computing Environment

In order to provide context for various aspects of the subject matter disclosed herein, FIG. 3 and the following discussion are intended to provide a brief general description of a suitable computing environment 510 in which various embodiments may be implemented. While the subject matter disclosed herein is described in the general context of computer-executable instructions, such as program modules, executed by one or more computers or other computing devices, those skilled in the art will recognize that portions of the subject matter disclosed herein can also be implemented in combination with other program modules and/or a combination of hardware and software. Generally, program modules include routines, programs, objects, physical artifacts, data structures, etc. that perform particular tasks or implement particular data types. Typically, the functionality of the program modules may be combined or distributed as desired in various embodiments. The computing environment 510 is only one example of a suitable operating environment and is not intended to limit the scope of use or functionality of the subject matter disclosed herein.

With reference to FIG. 3, a computing device for software development in the form of a computer 512 is described. Computer 512 may include a processing unit 514, a system memory 516, and a system bus 518. The processing unit 514 can be any of various available processors. Dual microprocessors and other multiprocessor architectures also can be employed as the processing unit 514. The system memory 516 may include volatile memory 520 and nonvolatile memory 522. Nonvolatile memory 522 can include read only memory (ROM), programmable ROM (PROM), electrically programmable ROM (EPROM) or flash memory. Volatile memory 520 may include random access memory (RAM) which may act as external cache memory. The system bus 518 couples system physical artifacts including the system memory 516 to the processing unit 514. The system bus 518 can be any of several types including a memory bus, memory controller, peripheral bus, external bus, or local bus and may use any variety of available bus architectures.

Computer 512 typically includes a variety of computer readable media such as volatile and nonvolatile media, removable and non-removable media. Computer storage media may be implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 512.

It will be appreciated that FIG. 3 describes software that can act as an intermediary between users and computer resources. This software may include an operating system 528 which can be stored on disk storage 524, and which can control and allocate resources of the computer system 512. Disk storage 524 may be a hard disk drive connected to the system bus 518 through a non-removable memory interface such as interface 526. System applications 530 take advantage of the management of resources by operating system 528 through program modules 532 and program data 534 stored either in system memory 516 or on disk storage 524. It will be appreciated that computers can be implemented with various operating systems or combinations of operating systems.

A user can enter commands or information into the computer 512 through an input device(s) 536. Input devices 536 include but are not limited to a pointing device such as a mouse, trackball, stylus, touch pad, keyboard, microphone, and the like. These and other input devices connect to the processing unit 514 through the system bus 518 via interface port(s) 538. An interface port(s) 538 may represent a serial port, parallel port, universal serial bus (USB) and the like. Output devices(s) 540 may use the same type of ports as do the input devices. Output adapter 542 is provided to illustrate that there are some output devices 540 like monitors, speakers and printers that require particular adapters. Output adapters 542 include but are not limited to video and sound cards that provide a connection between the output device 540 and the system bus 518. Other devices and/or systems or devices such as remote computer(s) 544 may provide both input and output capabilities.

Computer 512 can operate in a networked environment using logical connections to one or more remote computers, such as a remote computer(s) 544. The remote computer 544 can be a personal computer, a server, a router, a network PC, a peer device or other common network node, and typically includes many or all of the elements described above relative to the computer 512, although only a memory storage device 546 has been illustrated in FIG. 4. Remote computer(s) 544 can be logically connected via communication connection 550. Network interface 548 encompasses communication networks such as local area networks (LANs) and wide area networks (WANs) but may also include other networks. Communication connection(s) 550 refers to the hardware/software employed to connect the network interface 548 to the bus 518. Connection 550 may be internal to or external to computer 512 and include internal and external technologies such as modems (telephone, cable, DSL and wireless) and ISDN adapters, Ethernet cards and so on.

It will be appreciated that the network connections shown are examples only and other means of establishing a communications link between the computers may be used. One of ordinary skill in the art can appreciate that a computer 512 or other client device can be deployed as part of a computer network. In this regard, the subject matter disclosed herein man pertain to any computer system having any number of memory or storage units, and any number of applications and processes occurring across any number of storage units or volumes. Aspects of the subject matter disclosed herein may apply to an environment with server computers and client computers deployed in a network environment, having remote or local storage. Aspects of the subject matter disclosed herein may also apply to a standalone computing device, having programming language functionality, interpretation and execution capabilities.

FIG. 4 illustrates an integrated development environment (IDE) 600 and Common Language Runtime Environment 602. An IDE 600 may allow a user (e.g., developer, programmer, designer, coder, etc.) to design, code, compile, test, run, edit, debug or build a program, set of programs, web sites, web applications, and web services in a computer system. Software programs can include source code (component 610), created in one or more source code languages (e.g., Visual Basic, Visual J#, C++. C#, J#, Java Script, APL, COBOL, Pascal, Eiffel, Haskell, ML, Oberon, Perl, Python, Scheme, Smalltalk and the like). The IDE 600 may provide a native code development environment or may provide a managed code development that runs on a virtual machine or may provide a combination thereof. The IDE 600 may provide a managed code development environment using the .NET framework. An intermediate language component 650 may be created from the source code component 610 and the native code component 611 using a language specific source compiler 620 and the native code component 611 (e.g., machine executable instructions) is created from the intermediate language component 650 using the intermediate language compiler 660 (e.g. just-in-time (JIT) compiler), when the application is executed. That is, when an IL application is executed, it is compiled while being executed into the appropriate machine language for the platform it is being executed on, thereby making code portable across several platforms. Alternatively, in other embodiments, programs may be compiled to native code machine language (not shown) appropriate for its intended platform.

A user can create and/or edit the source code component according to known software programming techniques and the specific logical and syntactical rules associated with a particular source language via a user interface 640 and a source code editor 651 in the IDE 600. Thereafter, the source code component 610 can be compiled via a source compiler 620, whereby an intermediate language representation of the program may be created, such as assembly 630. The assembly 630 may comprise the intermediate language component 650 and metadata 642. Application designs may be able to be validated before deployment.

The various techniques described herein may be implemented in connection with hardware or software or, where appropriate, with a combination of both. Thus, the methods and apparatus described herein, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing aspects of the subject matter disclosed herein. In the case of program code execution on programmable computers, the computing device will generally include a processor, a storage medium readable by the processor (including volatile and non-volatile memory and/or storage elements), at least one input device, and at least one output device. One or more programs that may utilize the creation and/or implementation of domain-specific programming models aspects, e.g., through the use of a data processing API or the like, may be implemented in a high level procedural or object oriented programming language to communicate with a computer system. However, the program(s) can be implemented in assembly or machine language, if desired. In any case, the language may be a compiled or interpreted language, and combined with hardware implementations.

While the subject matter disclosed herein has been described in connection with the figures, it is to be understood that modifications may be made to perform the same functions in different ways.

What is claimed:

1. A system comprising:
a processor and a memory including an extensible data application development module that automatically adds a data model generated from a new type of data source to a plurality of data sources displayed in a user interface for form creation comprising a data source window, wherein the extensible data application development module automatically generates user interface code , data objects and data application code based on user input associating a data binding control with an element of the new type of data source and a designer.

2. The system of claim 1, further comprising an extensible data source provider wherein the extensible data source provider constructs a generalized data model from the new type of data source, wherein the generalized data model is compatible with a generic data source interface.

3. The system of claim 2, further comprising an extensible control enumerator, wherein the extensible control enumerator receives a current designer and returns a set of data binding controls associated with the current designer.

4. The system of claim 3, further comprising an extensible data object generator, wherein the extensible data object generator generates a data object for a combination of the current designer and the new type of data source.

5. The system of claim 3, further comprising an extensible user interface generator wherein the extensible user interface generator generates a user interface for the current designer and a selected data binding control of the set of data binding controls associated with the current designer.

6. The system of claim 3, further comprising an extensible data application code generator wherein the extensible data application code generator generates data application code based on the current designer and the extensible data source provider.

7. The system of claim 1, wherein a unified interface is called.

8. A method of extending data application development software using extensible data application development software comprising:
generating a generalized data model from a new type of data source using an extensible data source provider executing on a software development computer, wherein the generalized data model is compatible with a general data source interface;
detecting a current designer used with the extensible data application development software;
displaying a set of data binding controls compatible with the current designer;
associating a selected control of the set of displayed data binding controls compatible with the current designer with the new type of data source and the current designer;
generating an object associated with a combination of the extensible data source provider and the current designer; and
creating the object in a generalized format compatible with the extensible data application development software.

9. The method of claim 8, further comprising:
generating a user interface using an extensible user interface generator, wherein the generated user interface is associated with a pair comprising the current designer and the selected control.

10. The method of claim 8, further comprising:
generating data application code using an extensible data application code generator, wherein the generated data application code is associated with a pair comprising the current designer and the extensible data source provider, wherein the extensible data application code generator calls a unified interface.

11. The method of claim 8, wherein an extensible control enumerator receives the current designer and returns a set of controls for display wherein the set of displayed controls is compatible with the current designer.

12. The method of claim 8, wherein the current designer is associated with an extensible UI generator or is associated with an extensible code generator.

13. The method of claim 8, wherein application code generated by the extensible data application development software is dynamically composed using MEF.

14. The method of claim 8, wherein extensibility is based on a combination of one or more of: the current designer, the extensible data source provider, or the selected control.

15. A computer-readable storage medium comprising computer-executable instructions comprising extensible data application development software, which when executed cause at least one processor to:
generate a generalized data model from a new type of data source using an extensible data source provider executing on a software development computer, wherein the generalized data model is compatible with a general data source interface;
detect a current designer in use;
display a set of data binding controls compatible with the current designer;
associate in response to user input selecting a control from the displayed set of data binding controls compatible with the current designer, the selected control with the new type of data source and the current designer;
generate a user interface for the new type of data source for a pair comprising a combination of the current designer and the selected control using an extensible user interface generator.

16. The computer-readable storage medium of claim 15, comprising further computer-executable instructions, which when executed cause the at least one processor to:
generate an object for a pair comprising a combination of the extensible data source provider and the current designer; and
create the object in a generalized format compatible with the extensible data application development software.

17. The computer-readable storage medium of claim 15, comprising further computer-executable instructions, which when executed cause the at least one processor to:
generate data application code based on a pair comprising a combination of the current designer and the extensible data source provider using an extensible data application code generator, wherein the extensible data application code generator calls a unified interface.

18. The computer-readable storage medium of claim 15, comprising further computer-executable instructions, which when executed cause the at least one processor to:
provide points of extensibility within the extensible data application development software based on a combination of one or more of: the current designer, the extensible data source provider or the selected control.

19. The computer-readable storage medium of claim 15, comprising further computer-executable instructions, which when executed cause the at least one processor to:
construct a generalized data model from the new type of data source, wherein the generalized data source is compatible with a generic data source interface.

20. The computer-readable storage medium of claim 15, comprising further computer-executable instructions, which when executed cause the at least one processor to:
generate application code dynamically.
